(19) United States
(12) Patent Application Publication
(10) Pub. No.: US 2004/0251092 A1
(43) Pub. Date: Dec. 16, 2004

(54) Two stage device for applying brake pad force to a rotor with motor and expandable material

(76) Inventors: Dennis A. Kramer, Troy, MI (US); Frederick A. Jelley, Suttons Bay, MI (US); Joseph A. Kay, Highland, MI (US); James R. Brichta, Highland, MI (US); Dennis G. O'Reilly, Rochester Hills, MI (US); Christopher S. Keeney, Troy, MI (US); Jaeho Kwak, West Lafayette, IN (US)

Correspondence Address: CARLSON, GASKEY & OLDS, P.C., 400 WEST MAPLE ROAD, SUITE 350, BIRMINGHAM, MI, 48009, US

(21) Appl. No.: 10/459,052

(22) Filed: Jun. 11, 2003

(51) Int. Cl. F16D 55/08

(52) U.S. Cl. 188/72.1; 188/156; 188/158

(57) ABSTRACT

A brake system includes a rotor and a brake pad. An actuator is connected to the brake pad. The actuator includes an energy receptive material that expands when excited to move the brake pad into contact with a braking surface on the rotor. A drive unit moves the energy receptive material between a first position and a second position, where the second position is closer to the rotor than the first position. An energy source energizes the energy receptive material to expand, moving the brake pad into contact with the braking surface. A control unit controls the drive unit and the energy source.

### BACKGROUND OF THE INVENTION

This invention relates to a brake system for a motor vehicle.

A brake system for a motor vehicle typically comprises a pair of brake pads adjacent to opposing faces of a rotor. The rotor rotates with a wheel of the vehicle. A vehicle operator applies the brakes by actuating a brake pedal connected to a hydraulic or air actuator that moves the brake pads toward the rotor. These actuators are heavy and constructed from a large number of components.

Recently, manufacturers have sought to replace hydraulic or air braking with electrically controlled and actuated systems. Such systems greatly simplify braking and eliminate the heavy fluid lines and components associated with hydraulic or air braking systems. However, currently designed systems require a very large motor and electric current to create the forces required to stop a vehicle, particularly for commercial vehicle applications.

In addition, existing electrical braking systems are difficult to incorporate with anti-lock braking systems. Such systems must rapidly apply and release the brake pads from the rotor to prevent the brakes from locking. Pulsing the brakes for currently designed electrical braking systems imposes a tremendous burden on the vehicle's electrical system.

Manufacturers have considered using magnetostrictive or piezo-electric materials for braking systems. Such material is controllable to expand or contract in response to energy from a magnetic or electric source. A magnetostrictive material will expand in response to magnetic energy while piezo-electric material is responsive to electric current. However, such material will only expand and contract a very small amount. Consequently, manufacturers have limited their use of this material. Such material has been used to move brake pads to adjust for wear. The material has also been used as part of a hydraulic fluid pump to actuate a brake. Until now, manufacturers have been unable to develop commercially practical braking systems that use this material to actuate a brake directly.

A need therefore exists for an electrical braking system that provides sufficient braking force without the problems of current systems.

### SUMMARY OF THE INVENTION

The inventive brake system uses brake pads and a rotor to effect braking. The inventive electrical braking systems uses a unique actuator made from an energy receptive material, which expands when energized. The material may be a piezo-electric or magnetostrictive material, which directly actuates vehicle braking. By energizing the energy receptive material, the actuator expands so as to place the brake pad into contact with the rotor. Very little energy is required to cause this expansion. Nevertheless, the braking force generated by this expansion is more than sufficient for braking purposes.

The expansion of the energy receptive material is not very large, however. Consequently, the inventive braking system uses an innovative two-stage braking system and process to accommodate the small level of expansion of the energy receptive material. Prior to braking, the actuator is spaced from the rotor to allow the rotor to rotate without obstruction from the brake pads. When braking is required, a drive unit moves the energy receptive material to a location where its expansion will apply the brake pads to the rotor. An energy source then energizes the energy receptive material, expanding it and forcing the brake pad into further engagement with the rotor. A control unit serves to control the drive unit and the energy source. The inventive electrical braking system may be part of an anti-lock braking system.

The electrical braking system may employ a second brake pad and a second actuator. The second actuator may comprise an energy receptive material also expandable when excited to move the second brake pad into contact with the rotor. A second drive unit may move the second actuator into braking position.

Wear on the brake pads may cause the distance between the brake pads and rotor to change. Accordingly, a position sensor may be used to sense the position of the brake pad relative to the rotor. In this way, the control unit may then adjust the location of the actuator to account for brake wear.

The inventive braking system also uses a novel brake pad assembly with the energy receptive material. The brake pad assembly directly links the brake pad to the energy receptive material. As a consequence, expansion of the energy receptive material directly causes translational movement of the brake pad into the rotor. The energy receptive material may be a piezo-electric material or a magnetostrictive material.

According to the invention, a motor drives an energy receptive material towards the rotor. The energy receptive material is energized to cause its expansion. As a consequence of this expansion, the brake pad is moved into contact with the rotor, thereby slowing its movement.

The energy receptive material is preferably energized following its placement in proximity to the rotor. The brake pad's position may be sensed to place the brake pad in this proper position prior to the expansion of the material. The material may be energized by electric energy or magnetic energy depending upon the type of material. Moreover, the material may also be de-energized to cause its contraction and thereby move the brake pad away from the rotor when braking is no longer required. The material may be energized and de-energized repeatedly, or modulated, to effect anti-lock braking.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a schematic view of inventive brake system, comprising brake pad, actuator, and drive unit.

FIG. 2 illustrates the inventive brake system of FIG. 1 after drive unit moves brake pad into position with respect to braking surface.

FIG. 3 illustrates actuator placing brake pad into contact with braking surface.

FIG. 4 illustrates a schematic view of inventive brake system employing two actuators.

FIG. 5 illustrates a cross-sectional view of drive unit.

### DETAILED DESCRIPTION OF THE PREFERRED EMBODIMENT

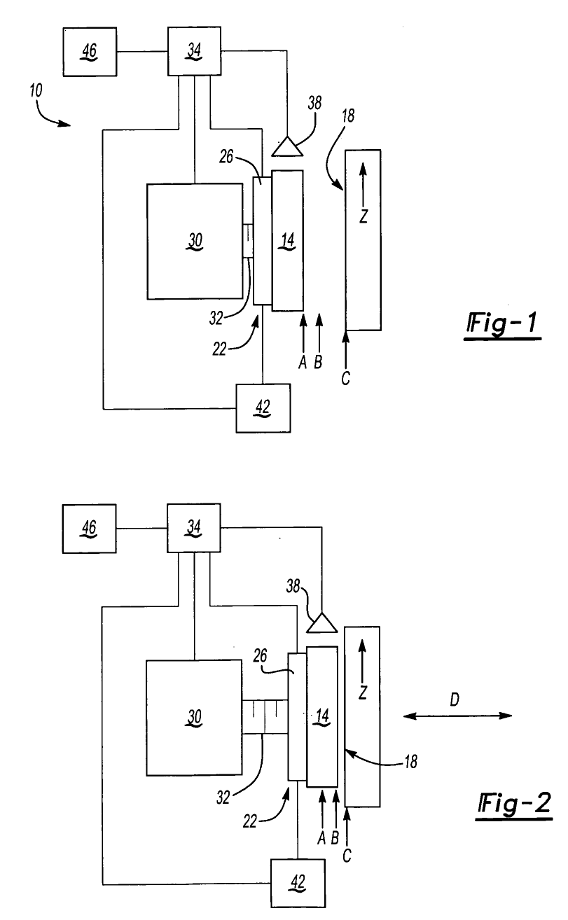

FIG. 1 illustrates a schematic view of brake system 10. Like existing electrical brake systems, inventive brake system 10 moves brake pad 14 into contact with braking surface 18, which is a face of a rotor spinning in the direction of arrow Z. However, in contrast to these systems, brake pad 14 is directly linked to a unique actuator 22 and further coupled to drive unit 30 by threaded shaft 32 to provide for a two-stage braking assembly and process that requires very little electrical energy.

Actuator 22 comprises energy receptive material 26, such as piezo-electric material or magnetostrictive material, which expands when excited by energy source 42. If the material is piezo-electric material, energy source 42 will electrically charge energy receptive material 26 to expand in size. If energy receptive material 26 comprises magnetostrictive material, then energy source 42 comprises a magnetic field generating device to magnetically energize energy receptive material 26. Such energy receptive material 26 is capable of producing substantial braking force from its expansion without significant energy consumption. As a consequence, inventive brake system 10 eliminates the need for a large electric motor to produce the large braking force required to brake a vehicle.

However, energy receptive material 26 expands only a tiny amount so that even wear on brake pad 14 may preclude brake pad 14 from moving into contact with braking surface 18 through expansion of energy receptive material 26 alone. Thus, inventive brake system 10 uses a two-stage assembly and process. As explained in greater detail below, the first stage moves brake pad 14 and actuator 22 into a position in which expansion of actuator 22 will place brake pad 14 into contact with braking surface 18. The second stage then energizes actuator 22 to produce the large forces to slow braking surface 18.

First, as shown in FIG. 1, inventive brake system 10 has drive unit 30 to move energy receptive material 26 into a position such that expansion of energy receptive material 26 places brake pad 14 into contact with braking surface 18. FIG. 2 shows drive unit 30 comprising threaded shaft 32 that moves actuator 22 and brake pad 14 translationally along path D through rotation of threaded shaft 32. Other commercially available drive units may be employed as well.

Referring back to FIG. 1, prior to operation of drive unit 30, position sensor 38 may be used to detect the location of brake pad 14 at position A with respect to the braking surface 18. If this location is too far for the expansion of energy receptive material 26 to move brake pad 14 into contact with braking surface 18, control unit 34, which is in communication with position sensor 38, instructs drive unit 30 to move energy receptive material 26 and brake pad 14 to position B, as shown in FIG. 2, by moving shaft 32.

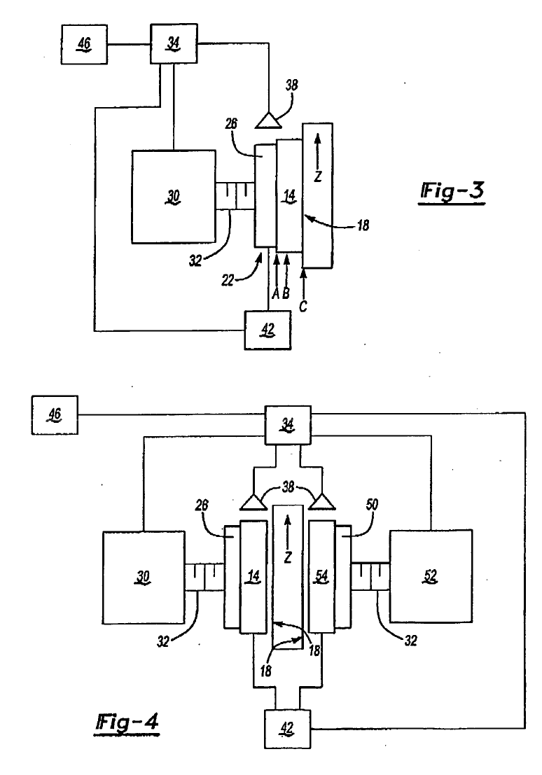

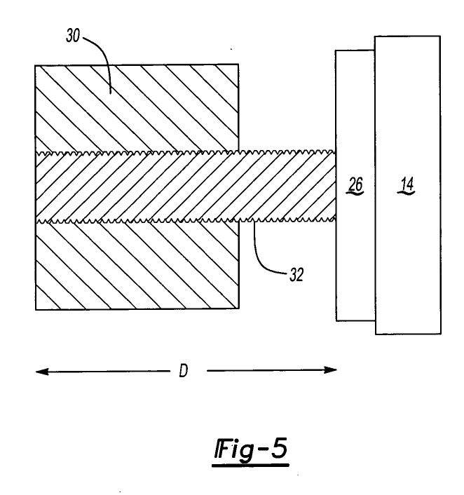

Second, once in position B, energy source 42 energizes energy receptive material 26 to cause its expansion and thereby move brake pad 14 from position B to position C, as shown in FIG. 3, and in contact with braking surface 18. Application of brake pad 14 on braking surface 18 slows movement of braking surface 18 along the direction of arrow Z.

When brake is no longer applied by the vehicle operator, energy source 42 is deactivated by control unit 34 causing energy receptive material 26 to contract and move brake pad 14 back to position B so that brake pad 14 is no longer in contact with braking surface 18. Alternatively, drive unit 30 may pull brake pad 14 away from braking surface 18 back to position B.

By repeatedly activating and deactivating energy source 42 and thereby energizing and de-energizing energy receptive material 26, brake pad 14 may be applied and then released from rotor 18. Accordingly, brake system 10 may be easily incorporated as part of an anti-lock braking system 46 in communication with control unit 34. The application and withdrawal of brake pad 14 from rotor 18 may be pulsed or modulated to prevent locking of brake pad 14 on rotor 18.

FIG. 4 illustrates the use of an additional brake pad and actuator as part of the system. As shown, braking surface 18 may be slowed by two brake pads on opposite sides of braking surface 18, brake pad 14 and brake pad 54. Brake pad 14 is actuable as previously described. In addition, brake pad 54 is directly linked to second actuator 50, another energy receptive material, which is linked by shaft 32 to drive unit 52. As previously described, control unit 34 controls actuation of actuator 50 so that brake pad 54 may assist brake pad 14 in slowing braking surface 18.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

1. A brake system, comprising:
a rotor having a braking surface;
a first brake pad;
a first actuator having an energy receptive material operatively connected to said first brake pad, the energy receptive material being expandable when energized;
a first drive unit that selectively moves said first actuator between a first position and a second position, said second position being closer to said rotor than said first position;
an energy source in communication with said energy receptive material;
a position sensor that senses a position of said first brake pad relative to said braking surface; and
a control unit in communication with said first drive unit, said energy source, and said position sensor, wherein said control unit evaluates whether the position sensed by said position sensor will allow the first brake pad to apply a braking force to a first side of said braking surface when said energy receptive material is expanded, and
wherein said control unit instructs said first drive unit to move said energy receptive material to the second position if the position sensed by said position sensor indicates that said first brake pad will not apply the braking force to the first side of said braking surface when the energy receptive material is expanded,
and wherein said control unit instructs said energy source to energize said energy receptive material to expand said energy receptive material such that the first brake pad applies the braking force to the first side of said braking surface from at least one of the first position and the second position.

2. The brake system of claim 1 wherein said energy receptive material comprises a piezo-electric material.

3. The brake system of claim 1 wherein said energy receptive material comprises a magnetostrictive material.

4. The brake system of claim 1 wherein said control unit modulates said energy source to prevent locking of said first brake pad on said braking surface.

5. The brake system of claim 1 further comprising a second brake pad and a second actuator, said second actuator comprising a second energy receptive material that is expandable when energized to move said second brake pad into contact with an opposing side of said braking surface.

6. The brake system of claim 5 further comprising a second drive unit to move said second actuator.

7. (Cancelled)

8. A method of braking, comprising the steps of:
sensing a position of a brake pad relative to a rotor having a braking surface;
selectively driving a drive unit to move an energy receptive material toward the rotor based on the position of the brake pad obtained from the sensing step, and the energy receptive material being expandable when energized, wherein the driving step is conducted if the position from the sensing step indicates that the brake pad will not apply a braking force to the braking surface when the energy receptive material is expanded;
energizing the energy receptive material to cause the energy receptive material to expand; and
moving the brake pad into contact with the braking surface through the expansion of the energy receptive material due to the energizing step.

9. The method of braking of claim 8 wherein the energizing step is conducted after the selectively driving step.

10. (Cancelled)

11. (Cancelled)

12. (Cancelled)

13. The method of braking of claim 8 wherein the energizing step comprises electrically exciting the energy receptive material.

14. The method of braking of claim 8 wherein the energizing step comprises magnetically exciting the energy receptive material.

15. The method of braking of claim 8 further comprising the step of
de-energizing the energy receptive material to cause the energy receptive material to contract and move the brake pad away from the braking surface.

16. The method of braking of claim 15 wherein the de-energizing step is conducted after the energizing step.

17. The method of braking of claim 16 further comprising repeating the energizing and de-energizing steps to effect anti-lock braking.
